(19) United States
(12) Patent Application Publication
(10) Pub. No.: US 2010/0242048 A1
(43) Pub. Date: Sep. 23, 2010

(54) RESOURCE ALLOCATION SYSTEM

(76) Inventors: James C. Farney, Burlingame, CA (US); Pierre Seigneurbieux, San Ramon, CA (US)

Correspondence Address: Stolowitz Ford Cowger LLP, 621 SW Morrison St, Suite 600, Portland, OR, 97205, US

(21) Appl. No.: 12/789,362

(22) Filed: May 27, 2010

Related U.S. Application Data
(63) Continuation of application No. 11/406,603, filed on Apr. 19, 2006.

(51) Int. Cl. G06F 9/50

(52) U.S. Cl. 718/104

(57) ABSTRACT

The present provides a resource allocation system, including providing a workstation session manager in a workstation, coupling a resource schedule manager to the workstation session manager, coupling a disk drive storage system to the resource schedule manager, and provisioning a workflow process on the desk drive storage system utilizing the resource schedule manager.

### RELATED CASES

The present application is a continuation of U.S. pending application Ser. No. 11/406,603 filed Apr. 19, 2006, all of which we incorporate herein.

The present invention relates generally to disk drive storage systems, and more particularly to a system for allocating resources on disk drive storage systems.

### BACKGROUND ART

The vast majority of network storage devices process device requests indiscriminately. That is, regardless of the identity of the requester or the type of request, each device request can be processed with equal priority. Given the exponential increase in network traffic across the Internet, however, more recent network-oriented computing devices have begun to provide varying levels of computing services based upon what has been referred to as a “policy based service differentiation model”.

In a policy based service differentiation model, the computing devices can offer many levels of service where different requests for different content or services which originate from different requestors receive different levels of treatment depending upon administratively defined policies. In that regard, a service level agreement (SLA) can specify a guaranteed level of responsiveness associated with particular content or services irrespective of any particular requester. By comparison, quality of service (QoS) terms specify a guaranteed level of responsiveness minimally owed to particular requestors.

The policy based service differentiation model is the logical result of several factors. Firstly, the number and variety of computing applications which generate requests across networks both private and public has increased dramatically in the last decade. Each of these applications, however, has different service requirements. Secondly, technologies and protocols that enable the provision of different services having different levels of security and QoS have become widely available. Yet, access to these different specific services must be regulated because these specific services can consume important computing resources such as network bandwidth, memory and processing cycles. Finally, business objectives or organizational goals can be best served when discriminating between different requests rather than treating all requests for computer processing in a like manner.

As device requests flow through the network and ultimately to a file system, storage systems provide the terminal point of data access. More particularly, in response to any data request originating in a network, a file storage device such as disk media ultimately physically retrieves the requested data. Accordingly, data caching systems at all levels of the network replicate data that ultimately can be physically retrieved from file storage. Like other elements of the network, however, response times attributable to file storage access can add considerable costs to the overall response time, particularly in high request volume circumstances.

Notably, storage centers such as a network attached storage (NAS) or redundant array of inexpensive disks (RAID) systems provide an abstraction layer such that disk assignment and block allocations remain hidden from data requestors. Yet, at some level in each of these storage centers, the allocation of data to particular physical blocks on particular physical storage media must occur. This physical allocation of data to portions of the storage medium can directly relate to which physical disk read arms can be used to access requested data. Presently, physical device resources in the storage center are allocated indiscriminately without regard to the identity of a data requestor or the type of data requested.

In general a disk storage system can access any file within the storage array. It defines how the computer interfaces with the attached disk storage, be it directly attached or attached through a network interface cable. The file system defines how the data is organized and located on the disk drives, file ownership and quotas, date of creation and change, and any recovery information associated with the file. The file system is the critical link between the logic data files and the physical disk drive storage systems. It not only manages the data files but also maps the files to the disk drive storage system.

Moreover, in data storage systems for business applications, the users of sophisticated storage systems are usually more adept at managing their business than managing their storage system. The tasks of provisioning the storage system to support the business needs can be a daunting task that leads to wasted resources, time and money. Many business managers are reluctant to invest in expensive storage systems because they fear the initial investment for the hardware is just the beginning of an expensive problem.

There have been many attempts to bridge the very significant gap between the inner workings of a business and the intricacies of the file system that manages the data that is so vital to the success of the business. To date the solution of choice seems to be to entrust the company data to service organizations that are file system knowledgeable and have little knowledge of the business they are serving. This arrangement leads to built-in lags that are part of the data storage and retrieval reality, when using such a service organization.

Some industries, such as movie or video production companies, manipulate massive amounts of highly confidential data. The data must be available when the key production resources are ready to process the next great block buster. In many the expense associated with the production personnel can be more significant than the data manipulation hardware itself. These instances require that the correct data is available on demand in files that might be in the 1 Megabyte to 25 Terabyte range. Any delay in the data availability can severely impact schedule and cost.

In order to address some of these concerns strategies have developed that monitor the quality of service and establish service level agreements. These approaches are passive tools that keep track delivery success and failure, but do not have any provision to assure successful delivery of data to an agreed level in an over subscribed system environment.

Thus, a need still remains for a resource allocation system to manage the storage system hardware provisioning in the face of changing business priorities. In view of the throughput demand generated by new applications, it is increasingly critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides a resource allocation system, including providing a workstation session manager in a workstation, coupling a resource schedule manager to the workstation session manager, coupling a disk drive storage system to the resource schedule manager, and provisioning a workflow process on the disk drive storage system utilizing the resource schedule manager.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is an architectural block diagram of a resource allocation system in an embodiment of the present invention;

FIG. 2 is a flow diagram of a workflow resource allocation transaction;

FIG. 3 is a diagram of a workflow process; and

FIG. 4 is a flowchart of a resource allocation system for the manufacture of the resource allocation system, in an embodiment of the present invention.

### DETAILED DESCRIPTION

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGs. The same numbers are used in all the drawing FIGs. to relate to the same elements.

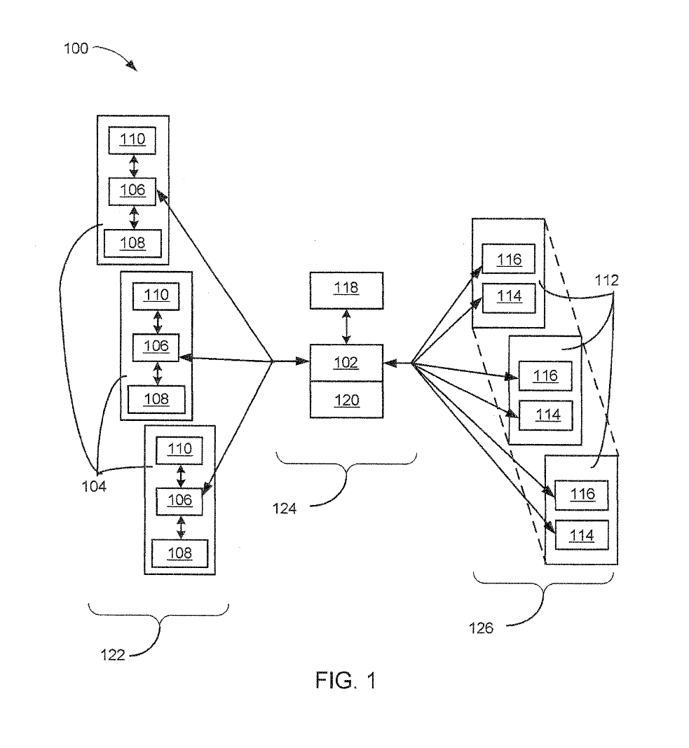

Referring now to FIG. 1 therein is shown an architectural block diagram of a resource allocation system 100 in an embodiment of the present invention. The architectural block diagram of the resource allocation system 100 includes a resource schedule manager 102 coupled to multiple instances of a workstation 104, having a workstation session manager 106 and a shared file system quality of service monitor 108. One of the resource schedule manager 102 may support up to 128 of the workstation session manager 106, each on the workstation 104. A graphical user interface 110 running on the workstation 104 transfers user requested jobs to the workstation session manager 106. The workstation session manager 106 transfers, the input from the graphical user interface 110, to the resource schedule manager 102 in order to provision resources from a disk drive storage system 112 for job support.

The resource schedule manager 102 couples to multiple instances of the disk drive storage system 112. One of the resource schedule manager 102 may support up to 16 instances of the disk drive storage system 112. Each instance of the disk drive storage system 112 includes an intelligent caching system 114 and a cache group controller 116. The resource schedule manager 102 communicates workflow criteria to the cache group controller 116. During the execution of the user requested job, the cache group controller 116 monitors the cache resource used by the job. The cache group controller 116 may change the allocated cache space for the job. The intelligent caching system 114 manages the data flow required to complete the user requested job.

A meta data server 118 is coupled to the resource schedule manager 102. The meta data server 118 keeps track of the physical location of the files associated with user requested job. A standby resource schedule manager 120 is clustered with the resource schedule manager 102 in order to maintain the support of the user requested job in the case of a component failure. The cluster support allows a clean transition between the standby resource schedule manager 120 and the failed instance of the resource schedule manager 102.

The resource allocation system 100 architecture has an end user layer 122, and an administration layer 124. The end user layer 122 is measured by a quality of service metric that is monitored by the shared file system quality of service monitor. The resource allocation system 100 is intended to maintain a very high user satisfaction ratio in over subscribed environments, where large data files are manipulated.

The administration layer 124 of the resource allocation system 100 is controlled by a facility administrator (not shown) that applies the facility business priorities to the user requested jobs. The administration layer 124 shares the available resources among the users. As the number of users exceeds the available resources, the business priorities and monitored job execution, allows the resource schedule manager 102 to make adjustments to the system operation that are transparent to the end user.

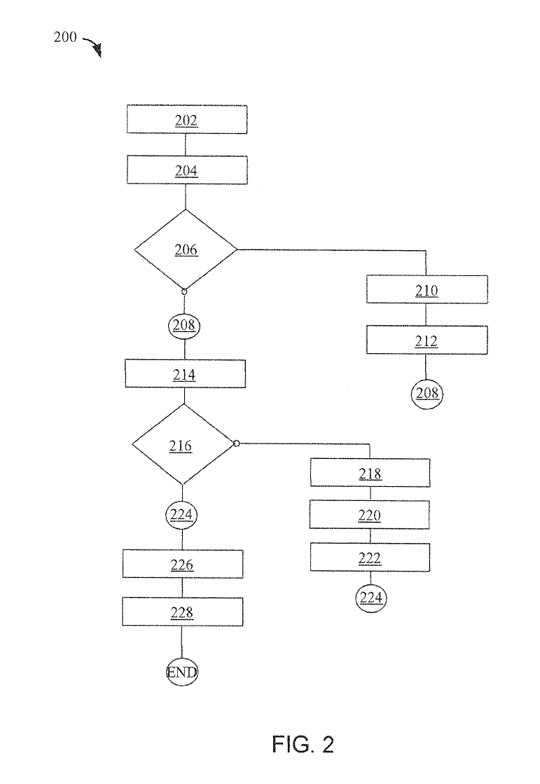

Referring now to FIG. 2 therein is shown a flowchart of a workflow resource allocation transaction 200. The flowchart of the workflow resource allocation transaction 200 depicts a GUI activated block 202, which is asserted when a user of the workstation 104, of FIG. 1, accesses the graphical user interface 110, of FIG. 1, to initiate a user requested job. The user of the workstation 104 selects a job from a list, such as 2K Grading, High Def 8-bit RGB, or the like. The user job select block 204 is activated when the user of the workstation 104 accesses the job list. When a job is selected from the list the flow steps to a parameter change decision block 206. In some cases a job may be initiated by a facility scheduling software, using a mechanism such as XML, as an automated request. In this case the exact parameters are set-up when the job is scheduled and no parameter change will be needed. The parameter change decision block 206 allows the user of the workstation 104 to request an enhanced parameter set with the selected job. If no parameter change is requested the flow steps to a first transition block 208, but if a parameter change is requested the flow steps to a parameter entry block 210.

A list of possible parameter settings is presented to the user of the workstation 104 by the graphical user interface 110. At the completion of the parameter selection, in the parameter entry block 210, the flow steps to an EDL (“Edit Decision List”) block 212. The EDL block 212 generates a parameter decision list, containing the list of files that will be included in the editing session, that is sent to the resource schedule manager 102, of FIG. 1, and the flow steps to the first transition block 208. A transmit request block 214 sends all of the parameters, for the user job, to the resource schedule manager 102 for analysis.

In a bandwidth available decision block 216 the resource schedule manager 102 checks the available bandwidth on the system to verify that the request can be supported. If there is sufficient available bandwidth the flow steps to a second transition block 224. If there is not sufficient available bandwidth to satisfy the request the flow steps to a verify priority block 218. The verify priority block 218 examines the priority of the user job request based on the information supplied by the user of the workstation 104. If this is a top priority request, user jobs of lesser priority may be impacted by a reduction in resources. With the relative priority of the job established, the flow steps to a verify business rules block 220.

The verify business rules block 220 formulates the action that will be taken to support the user job request. There are a multitude of possibilities based on the relative priority of the user job request relative to the other active jobs. A simple comparison fits the user requested job in the active queue, if the priority is low the user requested job may receive limited bandwidth to run or none at all. If the user requested job is of middle priority or high priority, it may be granted the full bandwidth to run. In this case lower priority jobs may be restricted or lose their bandwidth all together. In the case of an over subscribed system that has all high priority jobs, the decision is passed to a facility administrator for resolution.

When the flow steps from the verify business rules block 220, it enters the verify partial bandwidth block 222. In this step bandwidth limits and grants are resolved. As jobs are dynamic, this step in the flow applies the decisions from the verify business rules block 220 and generates notices that will be transmitted to users that are impacted by the decision. In the verify partial bandwidth block 222, any newly released bandwidth is applied to the previous decision prior to notification. The flow then steps to the second transition block 224.

The second transition block 224 immediately steps to an allocate resources block 226. The allocate resources block 226 formalizes the decisions made earlier in the flow. At this point the resource schedule manager 102 notifies the cache group controller 116, of FIG. 1, of the new parameters for the jobs affected. The new parameters are cut in as the flow steps to a notify users block 228. A message is transmitted from the resource schedule manager 102 to the workstation session manager 106, of FIG. 1, of all of the affected users. The workstation session manager 106 of the affected users passes the new job status to the graphical user interface 110 for display to the users. The flow steps to an END block to complete the operation.

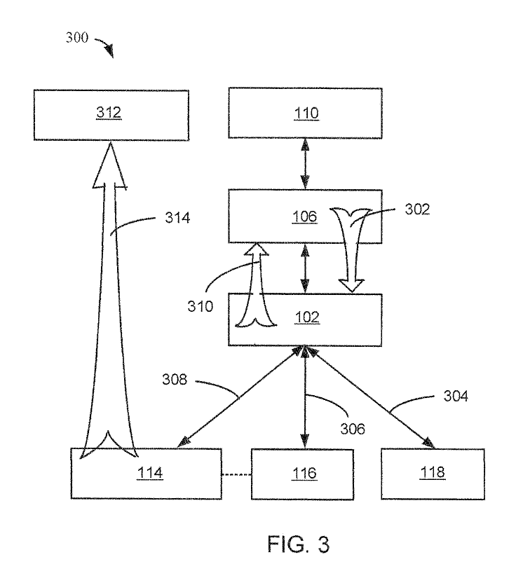

Referring now to FIG. 3, therein is shown a diagram of a workflow process 300. The flowchart of the workflow process 300 depicts a priority service request 302, which starts when the graphical user interface 110, of FIG. 1, initiates a job request. The priority service request 302 is generated by the workstation session manager 106, of FIG. 1, and sent to the resource schedule manager 102, of FIG. 1. The resource schedule manager 102 negotiates the priority service request 302 by comparing the request with all of the previously provisioned workflows. When the resource schedule manager 102 has resolved what level of resource will be assigned to the request, it starts to provision the hardware associated with the priority service request 302.

As part of the provisioning process the resource schedule manager 102 sends an MDS set-up message 304 to the meta data server 118, of FIG. 1, a CGC set-up message 306 to the cache group controller 116, of FIG. 1, and an ICS set-up message 308 to the intelligent caching system 114, of FIG. 1. In response to the ICS set-up message 308, the intelligent caching system 114 prepares to prefetch data from the disk drive storage system 112, of up to 2 Terabytes. The data that will be fetched includes the files that were identified in the EDL block 212, of FIG. 2. The actual prefetch of data takes place when the editing session starts and only the pertinent files are fetched. The resource schedule manager 102 responds, to the workstation session manager 106, with a provisioning message 310 once the hardware is assigned. A user application 312 receives an application data stream 314 from the intelligent caching system 114.

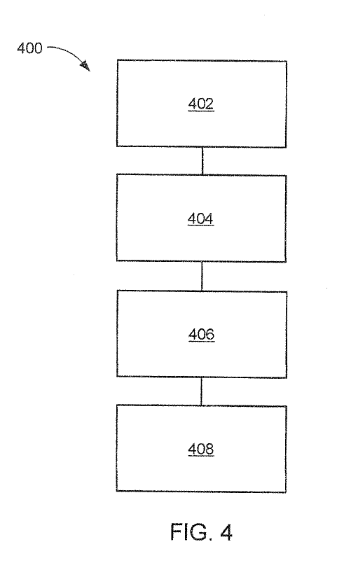

Referring now to FIG. 4, therein is shown a flowchart of a resource allocation system 400 for the manufacture of the resource allocation system 100, in an embodiment of the present invention. The system 400 includes providing a workstation session manager in a workstation in a block 402; coupling a resource schedule manager to the workstation session manager in a block 404; coupling a disk drive storage system to the resource schedule manager in a block 406; and provisioning a workflow process on the disk drive storage system utilizing the resource schedule manager.

It has been discovered that the present invention thus has numerous aspects.

It has been discovered that the present invention provides a resource allocation system that pro-actively addresses guaranteed data delivery in an over subscribed system environment. Another aspect of the present invention is its ability to dynamically adjust resource allocation to meet the data delivery goal.

Yet another aspect of the present invention is that the ability to scale the system to more users and more storage is very straight forward. By being workflow knowledgeable the interface is highly simplified making the resource allocation system easy to use.

It has been discovered that resource allocation system can be characterized to enhance the performance of specific system level operations while the storage system is in normal operation.

Thus, it has been discovered that the resource allocation system method and apparatus of the present invention furnish important and heretofore unknown and unavailable solutions, capabilities, and functional aspects for delivering high volumes of streaming data. The resulting processes and configurations are straightforward, cost-effective, uncomplicated, highly versatile and effective, can be implemented by adapting known technologies, and are thus readily suited for efficiently and economically manufacturing devices that are fully compatible with conventional manufacturing processes and technologies.

Thus, it has been discovered that the resource allocation system method and apparatus of the present invention furnish important and heretofore unknown and unavailable solutions, capabilities, and functional aspects for preserving disk drive system performance. The resulting processes and configurations are straightforward, cost-effective, uncomplicated, highly versatile and effective, can be implemented by adapting known technologies, and are thus readily suited for efficiently and economically manufacturing devices that are fully compatible with conventional manufacturing processes and technologies. In the context of this invention, the term “system” refers to both the method and apparatus of the invention.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters set forth herein or shown in the accompanying drawings are to be interpreted in an illustrative and non-limiting sense.

1. A method, comprising:
receiving a request to initiate a job, the request including one or more parameters configured to define one or more resources associated with the job;
determining available bandwidth;
in response to the available bandwidth being less than a bandwidth for execution of the job, determining priority of the job relative to one or more other jobs by comparing the one or more parameters associated with the job to one or more parameters associated with the one or more other jobs;
assigning bandwidth to the job responsive to the priority;
changing bandwidth assigned to the one or more other jobs responsive to the assigning the bandwidth to the job; and
causing allocation of at least a portion of the one or more resources to the job responsive to the assigning the bandwidth to the job.

2. The method of claim 1, further comprising:
notifying a storage controller of assigning the bandwidth to the job.

3. The method of claim 1, further comprising:
notifying a session manager configured to execute on a workstation of assigning the bandwidth to the job.

4. The method of claim 3, further comprising:
causing display of a notice on the workstation indicating the assigning the bandwidth to the job.

5. The method of claim 1, further comprising:
notifying a storage controller of changing the bandwidth assigned to the one or more other jobs.

6. The method of claim 1, further comprising:
notifying a session manager configured to execute on a workstation of changing the bandwidth assigned to the one or more other jobs.

7. The method of claim 6, further comprising:
causing display of a notice on the workstation indicating the changing the bandwidth assigned to the one or more other jobs.

8. The method of claim 1, further comprising:
assigning the bandwidth to the job responsive to determining an oversubscribed system.

9. A system, comprising:
means for receiving a request to initiate a job, the request including one or more parameters configured to define one or more resources associated with the job;
means for determining available bandwidth;
means for determining priority of the job relative to one or more other jobs by comparing the one or more parameters associated with the job to one or more parameters associated with the one or more other jobs responsive to the available bandwidth being less than a bandwidth for execution of the job;
means for assigning bandwidth to the job responsive to the priority;
means for changing bandwidth assigned to the one or more other jobs responsive to the bandwidth assigned to the job; and
means for causing allocation of at least a portion of the one or more resources to the job responsive to the bandwidth assigned to the job.

10. The system of claim 9, further comprising:
means for notifying a storage controller of the bandwidth assigned to the job.

11. The system of claim 9, further comprising:
means for notifying a session manager of the bandwidth assigned to the job.

12. The system of claim 11, further comprising:
means for causing display of a notice indicating the bandwidth assigned to the job.

13. The system of claim 9, further comprising:
means for notifying a storage controller of changing the bandwidth assigned to the one or more other jobs.

14. The system of claim 9, further comprising:
means for notifying a session manager of changing the bandwidth assigned to the one or more other jobs.

15. The system of claim 14, further comprising:
means for causing display of a notice indicating the changing the bandwidth assigned to the one or more other jobs.

16. The system of claim 9, further comprising:
means for assigning the bandwidth to the job responsive to determining an oversubscribed system.

17. An article of manufacture comprising a computer-readable medium having stored thereon computer executable instructions that configure a processing device to:
receive a request to initiate a job, the request including one or more parameters configured to define one or more resources associated with the job;
determine available bandwidth;
in response to the available bandwidth being less than a bandwidth for execution of the job, determine priority of the job relative to one or more other jobs by comparing the one or more parameters associated with the job to one or more parameters associated with the one or more other jobs;
assign bandwidth to the job responsive to the priority;
change bandwidth assigned to the one or more other jobs responsive to the bandwidth assigned to the job; and
cause allocation of at least a portion of the one or more resources to the job responsive to the bandwidth assigned to the job.

18. The article of claim 17 having stored thereon computer executable instructions further configuring the processing device to:
notify a storage controller of assigning the bandwidth to the job.

19. The article of claim 17 having stored thereon computer executable instructions further configuring the processing device to:
notify a session manager configured to execute on a workstation, of assigning the bandwidth to the job.

20. The article of claim 19 having stored thereon computer executable instructions further configuring the processing device to:
cause display of a notice on the workstation indicating the assigning the bandwidth to the job.

21. The article of claim 17 having stored thereon computer executable instructions further configuring the processing device to:
notify a storage controller of changing the bandwidth assigned to the one or more other jobs.

22. The article of claim 17 having stored thereon computer executable instructions further configuring the processing device to:
notify a session manager configured to execute on a workstation, of changing the bandwidth assigned to the one or more other jobs.

23. The article of claim 22 having stored thereon computer executable instructions further configuring the processing device to:
cause display of a notice on the workstation indicating the changing the bandwidth assigned to the one or more other jobs.

24. The article of claim 17 having stored thereon computer executable instructions further configuring the processing device to:
assign the bandwidth to the job responsive to determining an oversubscribed system.

25. A system, comprising:
a plurality of storage devices configured to store data;
a resource schedule manager configured to:
receive a request to initiate a job, the request including one or more parameters configured to define one or more resources associated with the job;
determine available bandwidth;
in response to the available bandwidth being less than a bandwidth for execution of the job, determine priority of the job relative to one or more other jobs by comparing the one or more parameters associated with the job to one or more parameters associated with the one or more other jobs;
assign bandwidth to the job responsive to the priority;
changing bandwidth assigned to the one or more other jobs responsive to the assignment of the bandwidth to the job; and
cause allocation of at least a portion of the one or more resources to the job responsive to the assigning the bandwidth to the job.

26. The system of claim 25, wherein the resource manager is further configured to:
notify a storage controller of assigning the bandwidth to the job.

27. The system of claim 25, wherein the resource manager is further configured to:
notify the session manager of assigning the bandwidth to the job.

28. The system of claim 27, wherein the resource manager is further configured to:
cause display of a notice indicating the assigning the bandwidth to the job.

29. The system of claim 25, wherein the resource manager is further configured to:
notify a storage controller of changing the bandwidth assigned to the one or more other jobs.

30. The system of claim 25, wherein the resource manager is further configured to:
notify the session manager of changing the bandwidth assigned to the one or more other jobs.

31. The system of claim 30, wherein the resource manager is further configured to:
cause display of a notice indicating the changing the bandwidth assigned to the one or more other jobs.

32. The system of claim 25, wherein the resource manager is further configured to:
assign the bandwidth to the job responsive to determining an oversubscribed system.
